(19) United States
(12) Patent Application Publication
(10) Pub. No.: US 2026/0192450 A1
(43) Pub. Date: Jul. 9, 2026

(54) ROBOT CONTROL METHOD, COMPUTER-READABLE STORAGE MEDIUM, AND ROBOT

(71) Applicant: UBTECH ROBOTICS CORP LTD, Shenzhen (CN)

(72) Inventors: SHENGWEN XIE, Shenzhen (CN); Ligang Ge, Shenzhen (CN)

(21) Appl. No.: 19/551,665

(22) Filed: Feb. 27, 2026

Related U.S. Application Data
(63) Continuation of application No. PCT/CN2024/143541, filed on Dec. 28, 2024.

(30) Foreign Application Priority Data
Oct. 30, 2024 (CN) 202411538873.8

(51) Int. Cl. B25J 9/16; B62D 57/032; G05D 1/495; G05D 109/12

(52) U.S. Cl. CPC B25J 9/1664; B25J 9/163; G05D 1/495; B62D 57/032; G05D 2109/12

(57) ABSTRACT

A robot control method, a computer-readable storage medium, and a robot are provided. The method includes: obtaining a leg trajectory planning result for a robot by performing a leg trajectory planning for the robot during the robot carrying a payload; determining, based on the leg trajectory planning result, a zero moment point reference trajectory for the robot; determining, based on the zero moment point reference trajectory, an equivalent centroid trajectory, wherein the equivalent centroid trajectory takes the robot and the payload as a whole; determining, based on the equivalent centroid trajectory, a centroid trajectory of the robot; obtaining a leg joint posture of the robot by performing an inverse kinematics solving based on the centroid trajectory of the robot; and controlling, based on the leg joint posture of the robot, the robot to move.

### CROSS REFERENCE TO RELATED APPLICATIONS

The present disclosure is a continuation-application of International Application PCT/CN2024/143541, with an international filing date of Dec. 28, 2024, which claims foreign priority of Chinese Patent Application No. 202411538873.8, filed on Oct. 30, 2024 in the State Intellectual Property Office of China, the contents of all of which are hereby incorporated by reference.

### TECHNICAL FIELD

The present disclosure relates to robotics technology, and particularly to a robot control method, a computer-readable storage medium, and a robot.

### BACKGROUND

Handling tasks are very common in daily life and industrial scenarios, and the use value of robots can be greatly improved by using the robots to perform handling tasks. In the existing technology, there are relatively mature robot control methods, but these robot control methods are mainly aimed at simple scenarios in which there is no payload on robot. In the scenario that a robot performs a handling task, the heavy object (i.e., payload) carried by the robot will have a great impact on the balance of the robot. If the existing robot control method is directly used, it will be difficult to maintain the walking stability of the robot.

In view of this, the embodiments of the present disclosure provide a robot control method, a computer-readable storage medium, and a robot to solve the problem of poor stability when performing handling task using the existing robot control method.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of a robot control method according to the first embodiment of the present disclosure.

FIG. 2 is a schematic diagram of the structure of a robot control apparatus according to an embodiment of the present disclosure.

FIG. 3 is a schematic diagram of a robot according to an embodiment of the present disclosure.

### DETAILED DESCRIPTION

In order to make the objects, features and advantages of the present disclosure more obvious and easy to understand, the technical solutions in the embodiments of the present disclosure will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including” and “comprising” indicate the presence of stated features, wholes, steps, operations, elements and/or components, but do not preclude the presence or addition of one or a plurality of other features, wholes, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “one”, “a”, and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the present disclosure, the terms “first”, “second”, “third”, and the like in the descriptions are only used for distinguishing, and cannot be understood as indicating or implying relative importance.

Handling tasks are very common in daily life and industrial scenarios, and the use value of robots can be greatly improved by using the robots to perform handling tasks. In the existing technology, there are relatively mature robot control methods, but these robot control methods are mainly aimed at simple scenarios in which there is no payload on robot. In the scenario that a robot performs a handling task, the heavy object (i.e., payload) carried by the robot will have a great impact on the balance of the robot. If the existing robot control method is directly used, it will be difficult to maintain the walking stability of the robot.

In view of this, the embodiments of the present disclosure provide a robot control method, a computer-readable storage medium, and a robot to solve the problem of poor stability when performing handling task using the existing robot control method.

In the embodiments of the present disclosure, during a robot carrying a payload, the robot and the payload are taken as a whole to perform a centroid trajectory planning, and perform a motion control on the robot on this basis, which fully considers the impact of the payload on the balance of the robot, thereby effectively improving the walking stability of the robot.

The subject of executing the method of the embodiments of the present disclosure may be a robot, including but not limited to industrial robot, home service robot, commercial service robot, or other type of robot.

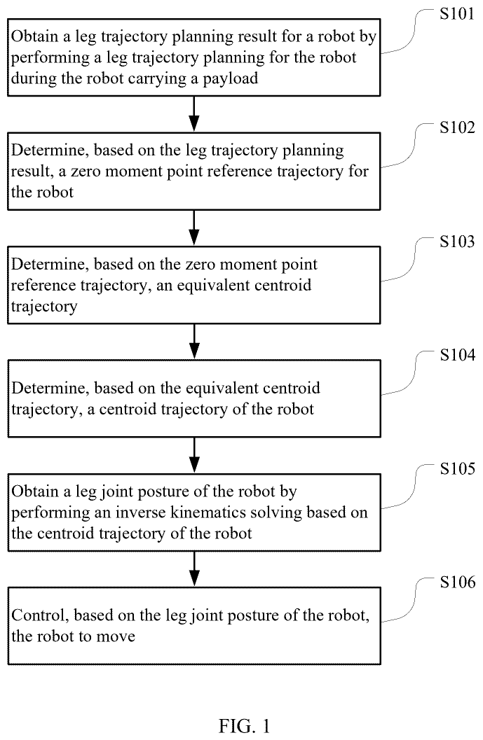

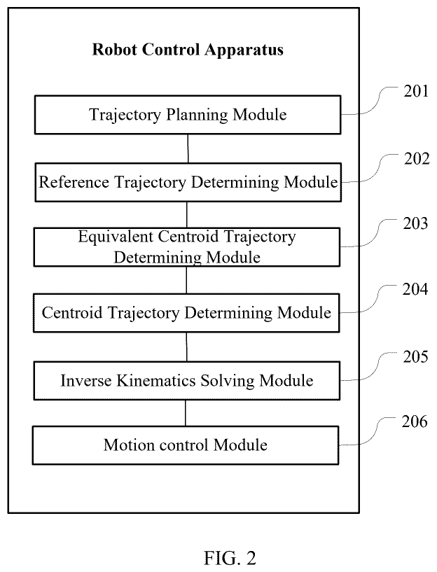

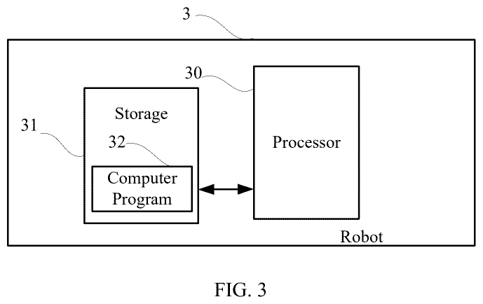

FIG. 1 is a flow chart of a robot control method according to the first embodiment of the present disclosure. In this embodiment, a method for controlling a robot is provided. The robot control method may be applied to (a processor of) the robot. The robot may be a humanoid robot that has legs including a left leg and a right leg and arms including a left arm and a right arm. In other embodiments, the method may be applied to a robot control apparatus as shown in FIG. 2 or a robot as shown in FIG. 3. In the scenario that the robot performs a handling task, it is moved with carrying a payload such as a heavy object. As shown in FIG. 1, in this embodiment, the method may include the following steps.

S101: obtaining a leg trajectory planning result for the robot by performing a leg trajectory planning for the robot during the robot carrying a payload.

In this embodiment, the leg trajectory planning may be performed on the left and right legs of the robot based on the distribution of obstacles in the surrounding environment in which the robot locates using any leg trajectory planning algorithm in the existing technology according to the actual needs. The leg trajectory planning result is obtained by planning based on obstacle avoidance requirements for the obstacles in the surrounding environment, which may include a left leg trajectory planning result and a right leg trajectory planning result that is the trajectory planning result of the left leg and the right leg, respectively.

S102: determining, based on the leg trajectory planning result, a zero moment point reference trajectory for the robot.

The zero moment point (ZMP) refers to a point on the ground at which the net moment about the parallel axis with respect to the ground (i.e., the x-axis and y-axis) that is jointly generated by the inertial force and the gravity is zero. At the ZMP on the ground supporting the robot, the sum of all horizontal moments (around the forward/backward and left/right axes) caused by gravity, inertial forces, and external forces acting on the robot is equal to zero.

In this embodiment, after obtaining the leg trajectory planning result, it may determine a central point trajectory of the two legs according to the left leg trajectory planning result and the right leg trajectory planning result to use as the zero moment point reference trajectory (i.e., the reference trajectory with respect to the zero-moment point) for the robot.

S103: determining, based on the zero moment point reference trajectory, an equivalent centroid trajectory.

In which, the equivalent centroid (center of mass, COM) is a centroid that considers the robot and the payload as a whole.

In this embodiment, a corresponding dynamics equation may be established based on any existing robot model. For the convenience of description, the linear inverted pendulum model (LIPM) is used as an example for detailed description. The LIPM simplifies the robot into an inverted pendulum on a horizontal plane, where all the mass is concentrated at the centroid, and the supporting surface is assumed to be horizontal without any friction. In the LIPM, the ankle joints of the robot are regarded as a whole as the coordinate origin (the midpoint of the line connecting the two ankles serves as the coordinate origin), and the centroid is at the top of the inverted pendulum. The length of the inverted pendulum is changed by moving the legs to maintain the balance and stable walking of the robot.

The dynamics equation corresponding to the LIPM may be as equations of:

$${X}_{k + 1} = {AX}_{k} + {Bu}_{k} ; and$$

$${Y}_{k} = {CX}_{k} ;$$

where, k is the sequence number of time step, 0≤k≤N, and N is the preset number of time steps; Xₖ is the state quantity related to the equivalent centroid at the k-th time step, Xₖ=[x_{com,k}, \dot{x}_{com,k}, \ddot{x}_{com,k}], x_{com,k} is the position of the equivalent centroid at the k-th time step, \dot{x}_{com,k} is the speed of the equivalent centroid at the k-th time step, \ddot{x}_{com,k} is the acceleration of the equivalent centroid at the k-th time step; uₖ= [symbol] _{com,k} is the jerk of the equivalent centroid at the k-th time step; A and B are preset parameter matrixes; C=[1,0, −h/g], h is the height of the robot, g is the gravity acceleration; and Yₖ is the zero moment point at the k-th time step.

An objective function for zero moment point tracking may be determined based on the dynamics equation of the robot and the zero moment point reference trajectory. First, it may determine, based on the dynamics equation of the robot and the reference trajectory with respect to the zero moment point, a tracking error term and an energy term of the zero moment point. Then, it may determine, based on the tracking error term, the energy term, a first weight corresponding to the tracking error term, and a second weight corresponding to the energy term, the objective function. Specifically, it may obtain a tracking error weighted term by weighting the tracking error term according to the first weight, then obtain an energy weighted term by weighting the energy term according to the second weight and finally determine a sum of the tracking error weighted term and the energy weighted term as the objective function, as an equation of:

$$J = {\sum }_{k = 0}^{N} [ {α ( {R}_{k} - {Y}_{k} )}^{2} + β {u}_{k}^{2} ] ;$$

where, Rₖ is the trajectory point of the zero moment point reference trajectory at the k-th time step; (Rₖ−Yₖ)² is the tracking error term; α is the first weight corresponding to the tracking error term; α(Rₖ−Yₖ)² is the tracking error weighted term;

$${u}_{k}^{2}$$

is the energy term; β is the second weight corresponding to the energy term;

$$β {u}_{k}^{2}$$

is the energy weighted term; and J is the objective function

The zero moment point of the robot should be located within the polygonal convex hull at the legs of the robot, which may be used to determine the constraints corresponding to the objective function as equations of:

$${CX}_{k} \leq {L}_{u} ; and$$

$${CX}_{k} \geq {L}_{l} ;$$

where, Lᵤ and Lₗ are the upper limit constraint and the lower limit constraint corresponding to the polygonal convex hull at the legs of the robot.

Based on the constraints and taking the minimization of the objective function as the optimization goal, it may perform model predictive control (MPC) on the robot to obtain the equivalent centroid trajectory by solving.

S104: determining, based on the equivalent centroid trajectory, a centroid trajectory of the robot.

In this embodiment, it may obtain the mass of the robot, the mass of the payload, and the centroid trajectory of the payload, and obtain the centroid trajectory of the robot by performing a centroid conversion on the equivalent centroid trajectory and the centroid trajectory of the payload based on a preset centroid conversion relationship according to the mass of the robot and that of the payload.

The centroid conversion relationship is a conversion relationship among the equivalent centroid, a centroid of the payload, and a centroid of the robot as equations of:

$$Mx * \vert Vx - Vp \vert = Mp * \vert Ve - Vp \vert ; and$$

$$Ve - Vp = K ( Vx - Ve ) ;$$

In which, Mx is the mass of the robot, Mp is the mass of the payload, K is the preset conversion coefficient, Vx is the centroid of the robot, Vp is the centroid of the payload, and Ve is the equivalent centroid.

S105: obtaining a leg joint posture of the robot by performing an inverse kinematics solving based on the centroid trajectory of the robot.

In this embodiment, the leg joint pose of the robot may include a left leg joint posture and a right leg joint posture that is the joint posture of the left leg and the right leg, respectively, which may be determined based on any existing inverse kinematics solving method including: analytic method-based inverse kinematics solving, value iteration-based inverse kinematics solving, optimization algorithm-based inverse kinematics solving, Jacobian matrix-based inverse kinematics solving, neural network-based inverse kinematics solving, or the like.

S106: controlling, based on the leg joint posture of the robot, the robot to move.

After the leg joint pose of the robot is obtained through inverse kinematics solving, the robot may be controlled to move according to the leg joint pose. Since the solving process of the leg joint pose has fully considered the impact of the payload on the balance of the robot, motion control based on this can effectively improve the walking stability of the robot.

The foregoing content is aimed at the walking process of the robot with carrying the payload. Before this, it may move the arms of the robot near the payload and perform compliant control in the direction of picking up the payload. For example, it may maintain a constant force to adjust the centroid while lifting the payload so that the centroid is always within the range of the legs.

During the robot lifting the payload, it may first determine an actual position, a desired position, an actual speed, and a desired speed of the equivalent centroid, and then determine, based on the actual position, the desired position, the actual speed, and the desired speed of the equivalent centroid, an adjustment amount of the equivalent centroid.

Specifically, it may determine, based on the actual position and the desired position of the equivalent centroid, a position deviation of the equivalent centroid; determine, based on the actual speed and the desired speed of the equivalent centroid, a speed deviation of the equivalent centroid; and determine based on the position deviation, the speed deviation, a proportional coefficient corresponding to the position deviation, and a differential coefficient corresponding to the speed deviation, the adjustment amount of the equivalent centroid after obtaining the position deviation and the speed deviation, as an equation of:

$$delta = kp ( xd - x ) + kd ( dxd - dx ) ;$$

where, xd is the desired position of the equivalent centroid; x is the actual position of the equivalent centroid; (xd-x) is the position deviation of the equivalent centroid; kp is the proportional coefficient corresponding to the position deviation; dxd is the desired speed of the equivalent centroid; dx is the actual speed of the equivalent centroid; (dxd-dx) is the speed deviation of the equivalent centroid; kd is the differential coefficient corresponding to the speed deviation; and delta is the adjustment amount of the equivalent centroid.

After determining the adjustment amount of the equivalent centroid, it may adjust the centroid according to the adjustment amount so that the centroid is always maintained within the range of the legs, thereby improving the walking stability of the robot.

After the robot carries the payload to walk to a target location, it may put down the payload. At this time, it may control the arms of the robot to move downward and detect the environmental force. If the detected environmental force is larger than a preset force threshold, it no longer moves the arms downward, but starts adjusting the centroid. The specific value of the force threshold may be flexibly set according to the actual needs. For example, it may be set to 20 Newton (N) or other values.

The centroid adjustment during putting down the payload is similar to that during lifting the payload. For details, refer to the foregoing descriptions. After completing the centroid adjustment, it may make the robot to turn off a force controller in the direction of picking up the payload, and then make the arms to leave the payload to complete the handling task.

In sum, in this embodiment, it obtains a leg trajectory planning result for the robot by performing a leg trajectory planning for the robot during the robot carrying a payload; determines, based on the leg trajectory planning result, a zero moment point reference trajectory for the robot; determines, based on the zero moment point reference trajectory, an equivalent centroid trajectory, where the equivalent centroid trajectory takes the robot and the payload as a whole; determines, based on the equivalent centroid trajectory, a centroid trajectory of the robot; obtains a leg joint posture of the robot by performing an inverse kinematics solving based on the centroid trajectory of the robot; and controlling, based on the leg joint posture of the robot, the robot to move. In this manner, during the robot carrying the payload, the robot and the payload are taken as a whole to perform a centroid trajectory planning, and perform a motion control on the robot on this basis, which fully considers the impact of the payload on the balance of the robot, thereby effectively improving the walking stability of the robot.

It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 2 is a schematic diagram of the structure of a robot control apparatus according to an embodiment of the present disclosure. As shown in FIG. 2, a robot control apparatus corresponding to the robot control method in the above-mentioned embodiment is provided.

In this embodiment, the robot control apparatus may be a controller of the above-mentioned robot, which may include:
a trajectory planning module 201 configured to obtain a leg trajectory planning result for the robot by performing a leg trajectory planning for the robot during the robot carrying a payload;
a reference trajectory determining module 202 configured to determine, based on the leg trajectory planning result, a reference trajectory with respect to a zero moment point for the robot;
an equivalent centroid trajectory determining module 203 configured to determine, based on the reference trajectory with respect to the zero moment point, an equivalent centroid trajectory, where the equivalent centroid trajectory takes the robot and the payload as a whole;
a centroid trajectory determining module 204 configured to determine, based on the equivalent centroid trajectory, a centroid trajectory of the robot;
an inverse kinematics solving module 205 configured to obtain a joint posture of the legs of the robot by performing an inverse kinematics solving based on the centroid trajectory of the robot; and
a motion control module 206 configured to control, based on the joint posture of the legs of the robot, the robot to move.

In some embodiments, the equivalent centroid trajectory determining module 203 may include:
a target function determining submodule configured to determine, based on a dynamics equation of the robot and the reference trajectory with respect to the zero moment point, an objective function for zero moment point tracking;
a constraint determination submodule configured to determine constraint conditions corresponding to the objective function; and
a model predictive control submodule configured to obtain the equivalent centroid trajectory by performing a model predictive control on the robot based on the constraint conditions to minimize the objective function.

In some embodiments, the target function determining submodule may include:
an error term and energy term determining unit configured to determining, based on the dynamics equation of the robot and the reference trajectory with respect to the zero moment point, a tracking error term and an energy term of the zero moment point; and
an objective function determining unit configured to determining, based on the tracking error term, the energy term, a first weight corresponding to the tracking error term, and a second weight corresponding to the energy term, the objective function.

In some embodiments, the objective function determining unit may be configured to obtain a tracking error weighted term by weighting the tracking error term according to the first weight; obtain an energy weighted term by weighting the energy term according to the second weight; and determine a sum of the tracking error weighted term and the energy weighted term as the objective function.

In some embodiments, the centroid trajectory determining module 204 may be configured to obtain a mass of the robot, a mass of the payload, and a centroid trajectory of the payload; and obtain the centroid trajectory of the robot by performing a centroid conversion on the equivalent centroid trajectory and the centroid trajectory of the payload based on a preset centroid conversion relationship according to the mass of the robot and the mass of the payload, where the centroid conversion relationship is a conversion relationship between the equivalent centroid, a centroid of the payload, and a centroid of the robot.

In some embodiments, the robot control apparatus may include:
a data determining module configured to determine an actual position, a desired position, an actual speed, and a desired speed of the equivalent centroid during the robot lifting or putting down the payload;
an adjustment amount determining module configured to determine, based on the actual position, the desired position, the actual speed, and the desired speed of the equivalent centroid, an adjustment amount of the equivalent centroid; and
an adjustment amount control module configured to control, based on the adjustment amount of the equivalent centroid, the robot to move.

In some embodiments, the adjustment amount determining module may be configured to determine, based on the actual position and the desired position of the equivalent centroid, a position deviation of the equivalent centroid; determine, based on the actual speed and the desired speed of the equivalent centroid, a speed deviation of the equivalent centroid; and determine, based on the position deviation, the speed deviation, a proportional coefficient corresponding to the position deviation, and a differential coefficient corresponding to the speed deviation, the adjustment amount of the equivalent centroid.

Those skilled in the art may clearly understand that, for the convenience and simplicity of description, for the specific operation process of the above-mentioned apparatus, modules and units, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

FIG. 3 is a schematic diagram of a robot according to an embodiment of the present disclosure. For convenience of description, only parts related to this embodiment are shown.

As shown in FIG. 3, in this embodiment, the robot 3 includes a processor 30, a storage 31, and a computer program 32 stored in the storage 31 and executable on the processor 30. When executing (instructions in) the computer program 32, the processor 30 implements the steps in the above-mentioned embodiments of the robot control method, for example, steps S101-S106 shown in FIG. 1. Alternatively, when the processor 30 executes the (instructions in) computer program 32, the functions of each module/unit in the above-mentioned device embodiments, for example, the functions of the modules 201-206 shown in FIG. 2 are implemented.

Exemplarily, the computer program 32 may be divided into one or more modules/units, and the one or more modules/units are stored in the storage 31 and executed by the processor 30 to realize the present disclosure. The one or more modules/units may be a series of computer program instruction sections capable of performing a specific function, and the instruction sections are for describing the execution process of the computer program 32 in the robot 3.

It can be understood by those skilled in the art that FIG. 3 is merely an example of the robot 3 and does not constitute a limitation on the robot 3, and may include more or fewer components than those shown in the figure, or a combination of some components or different components. For example, the robot 3 may further include an input/output device, a network access device, a bus, and the like.

The processor 30 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 31 may be an internal storage unit of the robot 3, for example, a hard disk or a memory of the robot 3. The storage 31 may also be an external storage device of the robot 3, for example, a plug-in hard disk, a smart media card (SMC), a secure digital (SD) card, flash card, and the like, which is equipped on the robot 3. Furthermore, the storage 31 may further include both an internal storage unit and an external storage device, of the robot 3. The storage 31 is configured to store the computer program 32 and other programs and data required by the robot 3. The storage 31 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/robot and method may be implemented in other manners. For example, the above-mentioned apparatus/robot embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any entity or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer-readable medium may be appropriately increased or decreased according to the requirements of legislation and patent practice in the jurisdiction. For example, in some jurisdictions, according to the legislation and patent practice, a computer-readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A method for controlling a robot having legs, comprising:
obtaining a leg trajectory planning result for the robot by performing a leg trajectory planning for the robot during the robot carrying a payload;
determining, based on the leg trajectory planning result, a reference trajectory with respect to a zero moment point for the robot;
determining, based on the reference trajectory with respect to the zero moment point, an equivalent centroid trajectory, wherein the equivalent centroid trajectory takes the robot and the payload as a whole;
determining, based on the equivalent centroid trajectory, a centroid trajectory of the robot;
obtaining a joint posture of the legs of the robot by performing an inverse kinematics solving based on the centroid trajectory of the robot; and
controlling, based on the joint posture of the legs of the robot, the robot to move.

2. The method of claim 1, wherein determining, based on the reference trajectory with respect to the zero moment point, the equivalent centroid trajectory comprises:
determining, based on a dynamics equation of the robot and the reference trajectory with respect to the zero moment point, an objective function for zero moment point tracking;
determining constraint conditions corresponding to the objective function; and
obtaining the equivalent centroid trajectory by performing a model predictive control on the robot based on the constraint conditions to minimize the objective function.

3. The method of claim 2, wherein determining, based on the dynamics equation of the robot and the reference trajectory with respect to the zero moment point, the objective function for zero moment point tracking comprises:
determining, based on the dynamics equation of the robot and the reference trajectory with respect to the zero moment point, a tracking error term and an energy term of the zero moment point; and
determining, based on the tracking error term, the energy term, a first weight corresponding to the tracking error term, and a second weight corresponding to the energy term, the objective function.

4. The method of claim 3, wherein determining, based on the tracking error term, the energy term, the first weight corresponding to the tracking error term, and the second weight corresponding to the energy term, the objective function comprises:
obtaining a tracking error weighted term by weighting the tracking error term according to the first weight;
obtaining an energy weighted term by weighting the energy term according to the second weight; and
determining a sum of the tracking error weighted term and the energy weighted term as the objective function.

5. The method of claim 1, wherein determining, based on the equivalent centroid trajectory, a centroid trajectory of the robot comprises:
obtaining a mass of the robot, a mass of the payload, and a centroid trajectory of the payload; and
obtaining the centroid trajectory of the robot by performing a centroid conversion on the equivalent centroid trajectory and the centroid trajectory of the payload based on a preset centroid conversion relationship according to the mass of the robot and the mass of the payload, wherein the centroid conversion relationship is a conversion relationship between the equivalent centroid, a centroid of the payload, and a centroid of the robot.

6. The method of claim 1, further comprising:
determining an actual position, a desired position, an actual speed, and a desired speed of the equivalent centroid during the robot lifting or putting down the payload;
determining, based on the actual position, the desired position, the actual speed, and the desired speed of the equivalent centroid, an adjustment amount of the equivalent centroid; and
controlling, based on the adjustment amount of the equivalent centroid, the robot to move.

7. The method of claim 6, wherein determining, based on the actual position, the desired position, the actual speed, and the desired speed of the equivalent centroid, the adjustment amount of the equivalent centroid comprises:
determining, based on the actual position and the desired position of the equivalent centroid, a position deviation of the equivalent centroid;
determining, based on the actual speed and the desired speed of the equivalent centroid, a speed deviation of the equivalent centroid; and
determining, based on the position deviation, the speed deviation, a proportional coefficient corresponding to the position deviation, and a differential coefficient corresponding to the speed deviation, the adjustment amount of the equivalent centroid.

8. A robot comprising:
a plurality of legs;
a processor;
a memory coupled to the processor; and
one or more computer programs stored in the memory and executable on the processor;
wherein, the one or more computer programs comprise:
instructions for obtaining a leg trajectory planning result for the robot by performing a leg trajectory planning for the robot during the robot carrying a payload;
instructions for determining, based on the leg trajectory planning result, a reference trajectory with respect to a zero moment point for the robot;
instructions for determining, based on the reference trajectory with respect to the zero moment point, an equivalent centroid trajectory, wherein the equivalent centroid trajectory takes the robot and the payload as a whole;
instructions for determining, based on the equivalent centroid trajectory, a centroid trajectory of the robot;
instructions for obtaining a joint posture of the legs of the robot by performing an inverse kinematics solving based on the centroid trajectory of the robot; and
instructions for controlling, based on the joint posture of the legs of the robot, the robot to move.

9. The robot of claim 8, wherein instructions for determining, based on the reference trajectory with respect to the zero moment point, the equivalent centroid trajectory comprise:
instructions for determining, based on a dynamics equation of the robot and the reference trajectory with respect to the zero moment point, an objective function for zero moment point tracking;
instructions for determining constraint conditions corresponding to the objective function; and
instructions for obtaining the equivalent centroid trajectory by performing a model predictive control on the robot based on the constraint conditions to minimize the objective function.

10. The robot of claim 9, wherein instructions for determining, based on the dynamics equation of the robot and the reference trajectory with respect to the zero moment point, the objective function for zero moment point tracking comprise:
instructions for determining, based on the dynamics equation of the robot and the reference trajectory with respect to the zero moment point, a tracking error term and an energy term of the zero moment point; and
instructions for determining, based on the tracking error term, the energy term, a first weight corresponding to the tracking error term, and a second weight corresponding to the energy term, the objective function.

11. The robot of claim 10, wherein instructions for determining, based on the tracking error term, the energy term, the first weight corresponding to the tracking error term, and the second weight corresponding to the energy term, the objective function comprise:
instructions for obtaining a tracking error weighted term by weighting the tracking error term according to the first weight;
instructions for obtaining an energy weighted term by weighting the energy term according to the second weight; and
instructions for determining a sum of the tracking error weighted term and the energy weighted term as the objective function.

12. The robot of claim 8, wherein instructions for determining, based on the equivalent centroid trajectory, a centroid trajectory of the robot comprise:
instructions for obtaining a mass of the robot, a mass of the payload, and a centroid trajectory of the payload; and
instructions for obtaining the centroid trajectory of the robot by performing a centroid conversion on the equivalent centroid trajectory and the centroid trajectory of the payload based on a preset centroid conversion relationship according to the mass of the robot and the mass of the payload, wherein the centroid conversion relationship is a conversion relationship between the equivalent centroid, a centroid of the payload, and a centroid of the robot.

13. The robot of claim 8, the one or more computer programs further comprise:
instructions for determining an actual position, a desired position, an actual speed, and a desired speed of the equivalent centroid during the robot lifting or putting down the payload;
instructions for determining, based on the actual position, the desired position, the actual speed, and the desired speed of the equivalent centroid, an adjustment amount of the equivalent centroid; and
instructions for controlling, based on the adjustment amount of the equivalent centroid, the robot to move.

14. The robot of claim 13, wherein instructions for determining, based on the actual position, the desired position, the actual speed, and the desired speed of the equivalent centroid, the adjustment amount of the equivalent centroid comprise:
instructions for determining, based on the actual position and the desired position of the equivalent centroid, a position deviation of the equivalent centroid;
instructions for determining, based on the actual speed and the desired speed of the equivalent centroid, a speed deviation of the equivalent centroid; and
instructions for determining, based on the position deviation, the speed deviation, a proportional coefficient corresponding to the position deviation, and a differential coefficient corresponding to the speed deviation, the adjustment amount of the equivalent centroid.

15. A non-transitory computer-readable storage medium for storing one or more computer programs, wherein the one or more computer programs comprise:
instructions for obtaining a leg trajectory planning result for a robot by performing a leg trajectory planning for the robot during the robot carrying a payload;
instructions for determining, based on the leg trajectory planning result, a reference trajectory with respect to a zero moment point for the robot;
instructions for determining, based on the reference trajectory with respect to the zero moment point, an equivalent centroid trajectory, wherein the equivalent centroid trajectory takes the robot and the payload as a whole;
instructions for determining, based on the equivalent centroid trajectory, a centroid trajectory of the robot;
instructions for obtaining a joint posture of legs of the robot by performing an inverse kinematics solving based on the centroid trajectory of the robot; and
instructions for controlling, based on the joint posture of the legs of the robot, the robot to move.

16. The storage medium of claim 15, wherein instructions for determining, based on the reference trajectory with respect to the zero moment point, the equivalent centroid trajectory comprise:
instructions for determining, based on a dynamics equation of the robot and the reference trajectory with respect to the zero moment point, an objective function for zero moment point tracking;
instructions for determining constraint conditions corresponding to the objective function; and
instructions for obtaining the equivalent centroid trajectory by performing a model predictive control on the robot based on the constraint conditions to minimize the objective function.

17. The storage medium of claim 16 wherein instructions for determining, based on the dynamics equation of the robot and the reference trajectory with respect to the zero moment point, the objective function for zero moment point tracking comprise:
instructions for determining, based on the dynamics equation of the robot and the reference trajectory with respect to the zero moment point, a tracking error term and an energy term of the zero moment point; and
instructions for determining, based on the tracking error term, the energy term, a first weight corresponding to the tracking error term, and a second weight corresponding to the energy term, the objective function.

18. The storage medium of claim 17, wherein instructions for determining, based on the tracking error term, the energy term, the first weight corresponding to the tracking error term, and the second weight corresponding to the energy term, the objective function comprise:
instructions for obtaining a tracking error weighted term by weighting the tracking error term according to the first weight;
instructions for obtaining an energy weighted term by weighting the energy term according to the second weight; and
instructions for determining a sum of the tracking error weighted term and the energy weighted term as the objective function.

19. The storage medium of claim 15, wherein instructions for determining, based on the equivalent centroid trajectory, a centroid trajectory of the robot comprise:
instructions for obtaining a mass of the robot, a mass of the payload, and a centroid trajectory of the payload; and
instructions for obtaining the centroid trajectory of the robot by performing a centroid conversion on the equivalent centroid trajectory and the centroid trajectory of the payload based on a preset centroid conversion relationship according to the mass of the robot and the mass of the payload, wherein the centroid conversion relationship is a conversion relationship between the equivalent centroid, a centroid of the payload, and a centroid of the robot.

20. The storage medium of claim 15, the one or more computer programs further comprise:
instructions for determining an actual position, a desired position, an actual speed, and a desired speed of the equivalent centroid during the robot lifting or putting down the payload;
instructions for determining, based on the actual position, the desired position, the actual speed, and the desired speed of the equivalent centroid, an adjustment amount of the equivalent centroid; and
instructions for controlling, based on the adjustment amount of the equivalent centroid, the robot to move.
